(19) United States
(12) Patent Application Publication
(10) Pub. No.: US 2015/0302172 A1
(43) Pub. Date: Oct. 22, 2015

(54) Method and Apparatus for Increasing Work Flow in a Pharmacy

(71) Applicant: Donald W. Grove, JR., Warsaw, MO (US)

(72) Inventor: Donald W. Grove, JR., Warsaw, MO (US)

(21) Appl. No.: 14/259,151

(22) Filed: Apr. 22, 2014

(51) Int. Cl. G06F 19/00; G06Q 10/06

(52) U.S. Cl. CPC G06F 19/3456; G06Q 10/0633; G06F 19/3431

(57) ABSTRACT

A pharmacy is arranged in a plurality of stations that are designated for certain purposes that are required to receive, fill, check, and distribute prescriptions. Further, a pharmacy is arranged to provide stations for patient education and counseling. The stations are separated to reduce distractions and errors and to isolate different parts of the process. Often, some of the stations are isolated from patient access to reduce patient disruptions. The embodiments further aim to provide a designation of urgency to in-progress prescriptions. The subject embodiment also aim to provide a method and apparatus for managing in-progress prescriptions. Horizontal rows are arranged vertically in a carousel configuration such that in-progress prescriptions are stored vertically, thus reducing the amount of horizontal space required.

### CROSS-REFERENCE TO RELATED APPLICATIONS

None.

### BACKGROUND OF THE INVENTION

The subject embodiments relate to pharmacy work flow, particularly relating to methods of increasing work flow in a pharmacy and various apparatuses for increasing work flow in a pharmacy. In particular, the embodiments relate to the utilization of separated work stations with designated functions within a pharmacy.

The current methods of work flow in a pharmacy are deficient for a plurality of reasons. Currently, pharmacies operate an open manner where the pharmacists and technicians work in an area that is visible and audibly accessible to patients. This method of work flow encourages disruptions and is detrimental to work flow optimization. Further, pharmacists and technicians work side-by-side in crowded horizontal work space and require increasingly more horizontal work space as prescription volume increases. Therefore, pharmacies that increase prescription volume inherently require increased horizontal space, thereby requiring a larger footprint for work areas.

Commonly, pharmacists and technicians work in a common area such that pharmacists and technicians work at the same station. The stations are configured where a common work space such as the common horizontal work space is shared by all working parties. This shared work space leads to crowding and errors that is increased as volume increases. Further, this shared work space introduces disruptions and distractions to the pharmacists and technicians from the pharmacists and technicians, thus leading to an increase in errors and a decrease in work flow.

Frequently, pharmacists and technicians are further distracted by the various other tasks that are required in addition to filling and checking prescriptions, such as answering phones and patient counseling. These various other tasks become distracting and decrease work flow within a pharmacy.

The current method for organizing and retaining in-progress prescriptions is the use of counting trays that are typically stacked. The trays often do not provide an adequate means for retaining identifying information. Further, trays have large footprints that consume a large amount of horizontal space and detract from available working space. If a tray is dropped or turned-over, the in-progress prescription becomes disorganized and requires the restarting of the filling and checking process. Additionally, trays do not offer any indication of urgency. Thus, more urgent trays are not easily identifiable from less urgent trays, which leads to inefficient work flow.

Consequently, pharmacies are in need of methods for increasing work flow to increase the volume of prescriptions that can be filled. Moreover, pharmacies are in need of methods and apparatuses for reducing needed horizontal work space, thus decreasing the required footprint of the pharmacy. Further still, pharmacies are in need of methods and apparatuses for improving in-progress prescription management. Consequently, methods and apparatuses for improving work flow in a pharmacy are desirable for both pharmacies and pharmacists.

### SUMMARY OF EMBODIMENTS

The embodiments described herein meet the objectives stated in the previous section, and provide a method and apparatus for increasing work flow in a pharmacy. A pharmacy is arranged in a plurality of stations that are designated for certain purposes that are required to receive, fill, check, and distribute prescriptions. Further, a pharmacy is arranged to provide stations for patient education and counseling. The stations are separated to reduce distractions and errors and to isolate different parts of the process. Often, some of the stations are isolated from patient access to reduce patient disruptions.

The embodiments further aim to provide a designation of urgency to in-progress prescriptions. In-progress prescriptions are retained in bags that are capable of being hung. Each in-progress prescription bag is designated with a measure of urgency based on the remaining time to fill the prescription. Often, the bag is designated with a color that is indicative of urgency. For example, a red bag indicates the prescription must be filled within 30 minutes, whereas a green bag indicates the prescription must be filled by the next day. Further, the bags are organized based on the drop-off time and date of the prescription. ADD alphabetical

A further aim is to provide a method for virtual patient counseling to reduce the amount of time the pharmacist is not checking prescriptions. The patient receives counseling related to filled prescriptions in a manner that does not require direct person-to-person interaction with the pharmacist. Various methods provide for virtual patient counseling including, for example, pre-recorded video, real-time video, phone transmission, text messaging, pre-recorded voice transmission, and pre-written descriptions. Further, virtual patient counseling may be accessed via an interactive tag on the prescription such as a QR Code or UPC code.

A further aim of the embodiments is to provide a method of hands-free communication for technicians to allow for continued prescription filling while attending to other work-related duties. The method provides for hands-free communication while completing a plurality of tasks. Some tasks include, for example, phone interaction, drive-up window interaction, hands-free typing (i.e. dictation), and hands-free dialing.

The subject embodiment also aim to provide a method and apparatus for managing in-progress prescriptions. Horizontal rows are arranged vertically in a carousel configuration such that in-progress prescriptions are stored vertically, thus reducing the amount of horizontal space required. Each horizontal row comprises a coupled structure that allows for the hanging of in-progress prescription retaining bags. Additionally, each horizontal row comprises a surface, often a shelf, for retaining larger prescription items not capable of being hung. Further, each horizontal row is divided into segments that represent at least one in-progress prescription. Each section comprises means to indicate the location of a desired in-progress prescription, either visually or audibly. Often, each horizontal row is capable of rotating.

Accordingly, several advantages are to provide a method and apparatus for increasing work flow in a pharmacy, to provide a designation of urgency to in-progress prescriptions, to provide a method for virtual patient counseling, to provide a method for hands-free communication, and to provide a method and apparatus for managing in-progress prescriptions. Still further advantages will become apparent from a study of the following descriptions and the accompanying drawings.

### BRIEF DESCRIPTION OF THE DRAWINGS

The drawings and embodiments described herein are illustrative of multiple alternative structures, aspects, and features of the embodiments described and claimed herein, and they are not to be understood as limiting the scope of the embodiments. It will be further understood that the drawing figures described and provided herein are not to scale, and that the embodiments are not limited to the precise arrangements and instrumentalities shown.

FIG. 1 is a flow chart of the various stations of the method for increasing work flow in a pharmacy, according to multiple embodiments and alternatives.

FIG. 2 is a flow chart of the method of an interactive voice response system, according to multiple embodiments and alternatives.

FIG. 3 is a flow chart of the method for designating urgency of in-progress prescriptions, according to multiple embodiments and alternatives.

FIG. 4 is a flow chart of the method for virtual patient counseling, according to multiple embodiments and alternatives.

FIG. 5 is a flow chart of a pharmacy with a robotic filling system, according to multiple embodiments and alternatives.

FIG. 6 is a flow chart of a method for managing in-progress prescriptions, according to multiple embodiments and alternatives.

FIG. 7 is a plan view of an in-progress prescription retaining device, according to multiple embodiments and alternatives.

FIG. 8 is a plan view of an in-progress prescription management apparatus, according to multiple embodiments and alternatives.

FIG. 9 is a plan view of a linear in-progress prescription management apparatus, according to multiple embodiments and alternatives.

### DETAILED DESCRIPTION OF EMBODIMENTS

According to multiple embodiments and alternatives herein, a method and apparatus for increasing work flow in a pharmacy and applications thereof shall be discussed in the present section.

A plurality of embodiments comprises methods and apparatuses for increasing work flow in a pharmacy. Said methods and apparatuses further comprise various structures, methods, and steps.

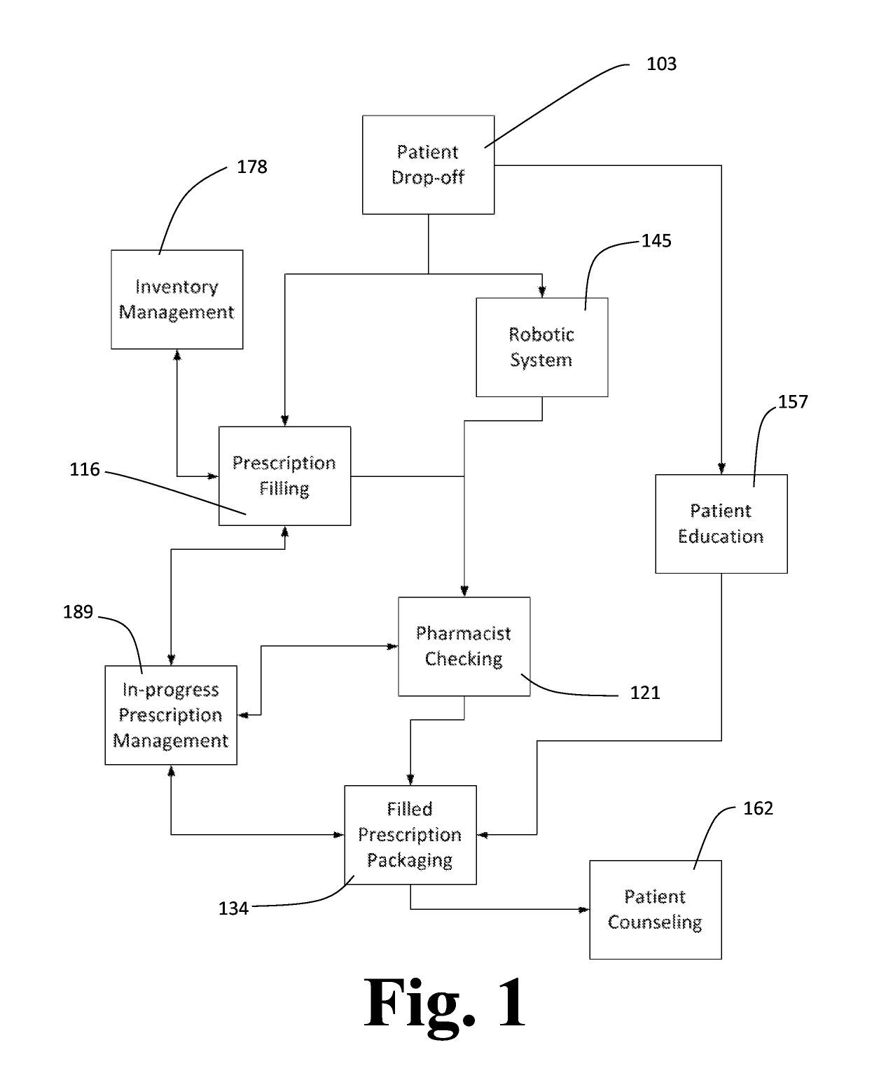

FIG. 1 shows a method for increasing work flow in a pharmacy comprising various stations that are designated for completion of certain tasks that are essential to the proper operation of a pharmacy. Commonly, a pharmacy requires the completion of the following tasks to successfully fill a prescription prescribed to any given patient including, for example, receiving a prescription order from patient drop-off, filling said prescription order by a technician, checking said prescription order by a pharmacist, packaging said filled prescription for delivery (i.e. in-store, shipping, etc.), and patient education and counseling concerning said prescription. Further tasks within this work flow include management of drug inventory and management of in-progress prescriptions.

Still referring to FIG. 1, the patient drop-off station 103 is occupied by at least one technician that is responsible for receiving prescriptions from patients in a plurality of manners. The patient drop-off station 103 will receive prescriptions via, for example, in-person drop-off at counter, interactive voice response system, synchronization orders, e-scripts, and drop-off at drive-up window. The technician at the drop-off station 103 checks the prescription for errors and fills in the necessary prescription information including, for example, patient name, patient contact information, desired pick-up time, and others. The technician then forwards the prescription order to the pharmacist checking station for a pre-check, wherein the pharmacist checks the prescription for accuracy and performs a drug utilization review (DUR) before releasing to the next verification steps. The next verification step includes, for example, insurance verification. Further, an urgency designation is assigned to the prescription at the drop-off station 103 based on patient need, wherein urgency designations include, for example, waiters (i.e. 30 minutes to an hour), 3 to 6 hours, next day, and special cases (i.e. insurance rejects, downed IT systems, special orders, special counseling, etc.).

Again referring to FIG. 1, the prescription filling station 116 is occupied by at least one technician that is responsible for the initial filling of the prescription including, for example, retrieving the main drug inventory retaining device, measuring the prescribed dosage, packaging the prescribed dosage and prescription information for pharmacist checking, and replacing the main drug inventory retaining device. The technician at the prescription filling station 116 may also retrieve prescriptions from the robotic system 145 that will be described in later paragraphs. A technician receives a prescription order and a label is printed with the required filling and verification information including, for example, drug, dosage, patient information, patient instructions, special information, and other required information. The technician then retrieves the main drug inventory retaining device from the inventory management system (e.g. shelving, vertical carousel, robotic system, etc.). The prescriptions are then organized according to alphabetical order, arrival time, and urgency. Prescriptions of higher urgency are filled prior to prescriptions of lesser urgency. The technician then prepares the prescription for checking by the pharmacist at the pharmacist checking station 121.

In some embodiments, the prescription filling station is arranged such that each technician works at a cubicle that is isolated from other technicians by vertical structures, often walls. Each cubicle includes, for example, a hanging area for in-progress prescription retaining devices, a personal belonging storage area, at least one printer, a hands-free communication device, and an isolated large horizontal working area. The prescription filling station is optimized to promote increased productivity and to limit disruptions. The prescription filling station further provides ergonomic design including, for example, a hands-free communication device to reduce injury due to repetitive movement.

Further still, as shown in FIG. 1, the pharmacist checking station 121 is occupied by at least one pharmacist who checks prescriptions prior to packaging for delivery. The pharmacist checking station 121 is separated from the prescription filling station and the patient drop-off station to reduce distractions and disruptions, thus improving work flow and increasing volume of prescriptions checked. Further, the pharmacist checking station 121 and the prescription filling station 116 may be isolated from patient access to reduce disruptions. The pharmacist checking station 121 is similarly organized by alphabetical order, arrival time, and urgency to allow for optimized work flow and increased volume of prescription checking. Further, noise level around the pharmacist checking station 121 is reduced to allow for reduced distraction. Following verification by the pharmacist, the prescription is transferred to the filled prescription packaging station in a pharmacist bundling bag.

As FIG. 1 additionally illustrates, the filled prescription packaging station 134 is occupied by at least one technician who prepares the prescriptions of a patient for final delivery. In the case of a patient having multiple prescriptions, for example, the prescriptions are consolidated to a common retaining device for delivery and a batch label is printed that represents all of the filled prescriptions for the particular patient, thus reducing the amount of time to retrieve the filled prescription for the patient. The technician further organized filled prescriptions such that they are easily retrievable for delivery to the patient. Similarly, the filled prescription packaging station is organized alphabetically and by urgency to optimize work flow and decrease wait-time for the patient. In some embodiments, the filled prescription packaging station 134 is isolated from patient access to facilitate easier compliance with regulatory requirements including, for example, Health Insurance Portability and Accountability Act (HIPAA) requirements and theft reduction. Pharmacist bundling bags are also often utilized at this station to eliminate prescription errors and incorrect combinations following prescription verification.

Still referring to FIG. 1, the patient education station 157 is not occupied by a technician or pharmacist. Accordingly, the patient education station 157 comprises education materials in form of videos, audio recordings, and hand-outs. Said education materials allow the patient to be educated around medications and home medical equipment while waiting for a prescription to be filled. Additionally, the patient education station 157 may comprise a blood pressure measuring device or other health sensors to measure various health statistics. Further, the patient may be provided educational information specific to the prescription to be filled including information related to adherence and proper dosage.

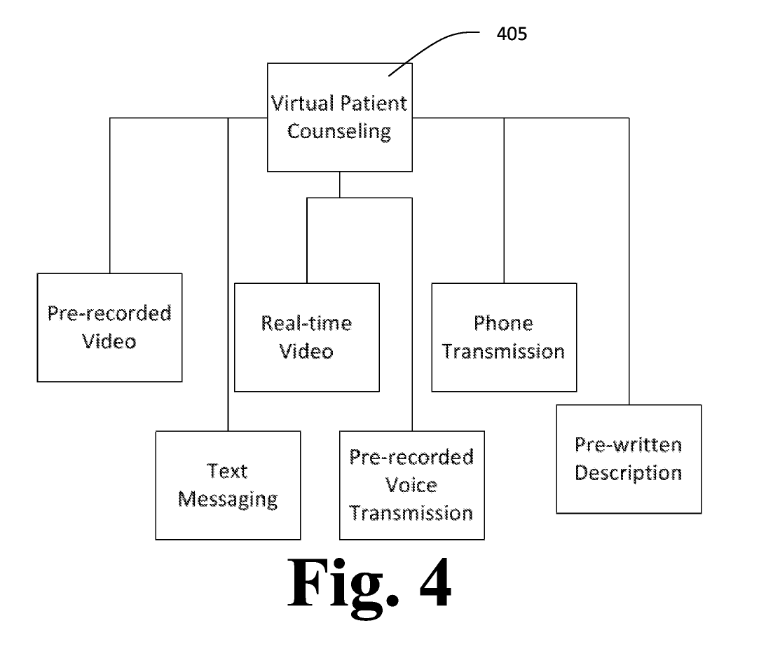

Again referring to FIG. 1, the patient counseling station 162 may be occupied by a technician or pharmacist. Optionally, the patient counseling station 162 may be configured to allow for virtual patient counseling as illustrated in FIG. 4, described below. The patient counseling station 162 may comprise two windows, wherein one can be of a larger size to accommodate larger groups. The smaller of the two windows provides a more private consultation between the pharmacist and patient. Further, the patient counseling station 162 comprises the counseling materials required by the pharmacist including, for example, props, hand-outs, and others. Optionally, the patient counseling station 162 does not comprise a seating device for the patient to encourage more expedient counseling stations, thus increasing work flow of the pharmacy.

Further shown in FIG. 1, the inventory management station 178 comprises the main drug inventory retaining devices that store the larger volumes of drugs that are counted for each prescription. In some embodiments, for example, the inventory management station 178 is at least one shelf, or, in other embodiments, the inventory management station 178 is at least one inventory carousel that provides for vertical organization, which decreases horizontal space requirements. Additionally, at least partially, the inventory management station 178 may comprise a robotic system that retrieves drug inventory and fills prescriptions for checking by the pharmacist.

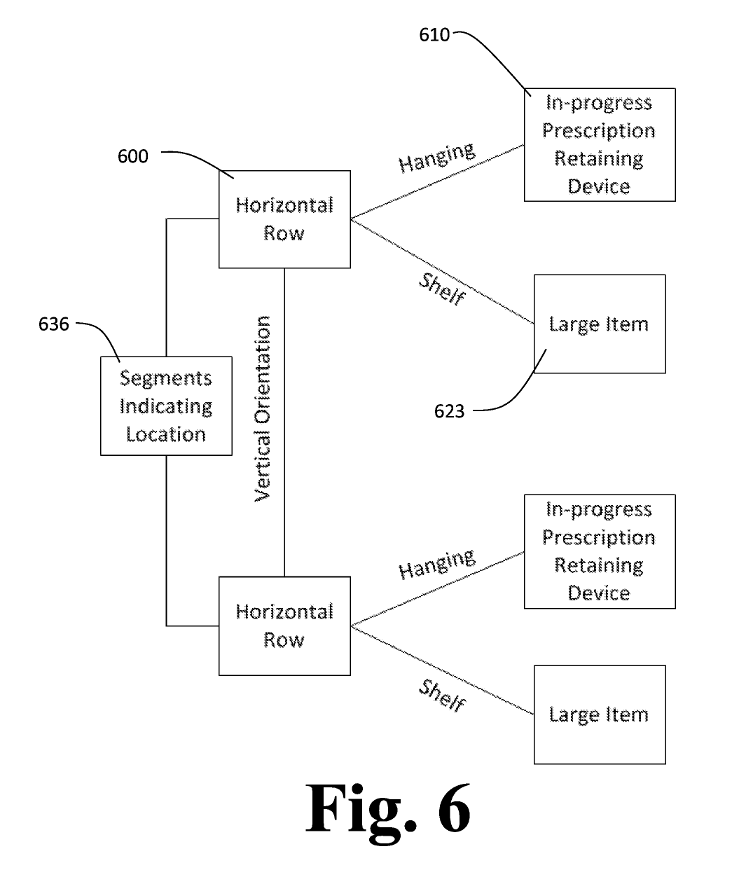

Further illustrated by FIG. 1, an in-progress prescription management station 189 may be arranged within another station. The in-progress prescription management station 189 is configured to allow for the organization of in-progress prescriptions according to arrival time, urgency, and patient name. Further, the in-progress prescription management station 189 may be vertically oriented such that in-progress prescriptions are stored in a more vertical orientation to reduce required horizontal storage space. The in-progress prescription management method is further illustrated in FIG. 6, described below.

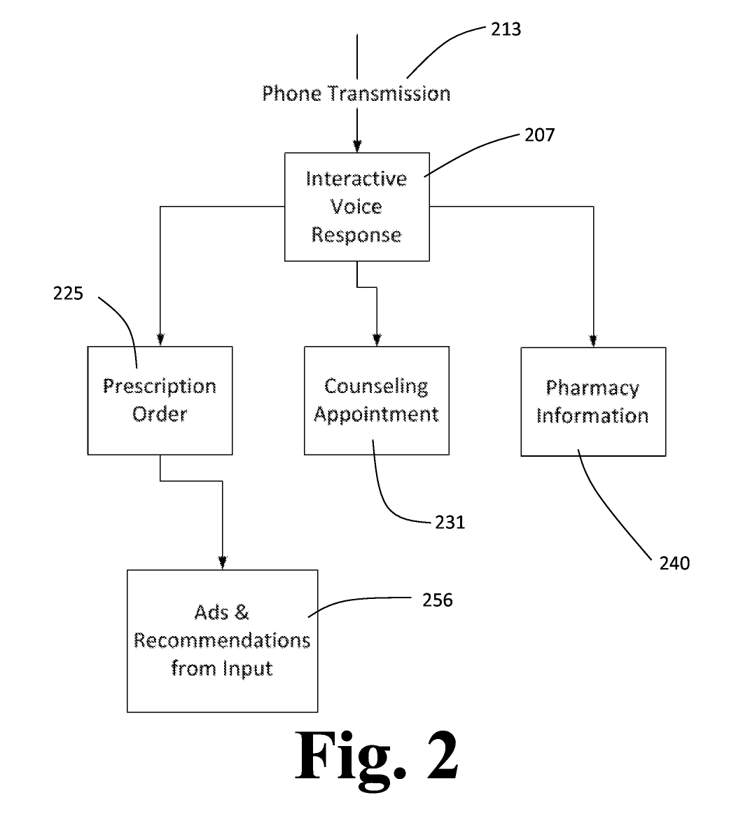

Referring now to FIG. 2, an interactive voice response (IVR) system 207 is configured to receive patient input via phone transmission 213 such that a patient calls a designated phone number and responds to prompts to accomplish desired tasks including, for example, prescription order 225, counseling appointment 231, pharmacy information 240, and others. The IVR system 207 retains patient input including prescription orders and transmits said prescription orders to the patient drop-off station such that prescriptions orders are started in the filling process. Often, the IVR system 207 receives and retains prescription orders when technicians are busy or the pharmacy is not operating. Additionally, the IVR system 207 allows for the patient to request in-person communication with a technician or pharmacist.

Again referring to FIG. 2, the IVR system 207 further comprises additional information and prompts based upon the information input by the patient. For example, the patient may input a prescription order 225 and the IVR system 207 may provide advertising or recommendations 256 that are related to the prescription order 225 or the condition meant to be treated by the prescription order. Additionally, the IVR system 207 may provide advertisements for products that are commonly used with the prescription order 225 or for the particular patient population related to the prescription order.

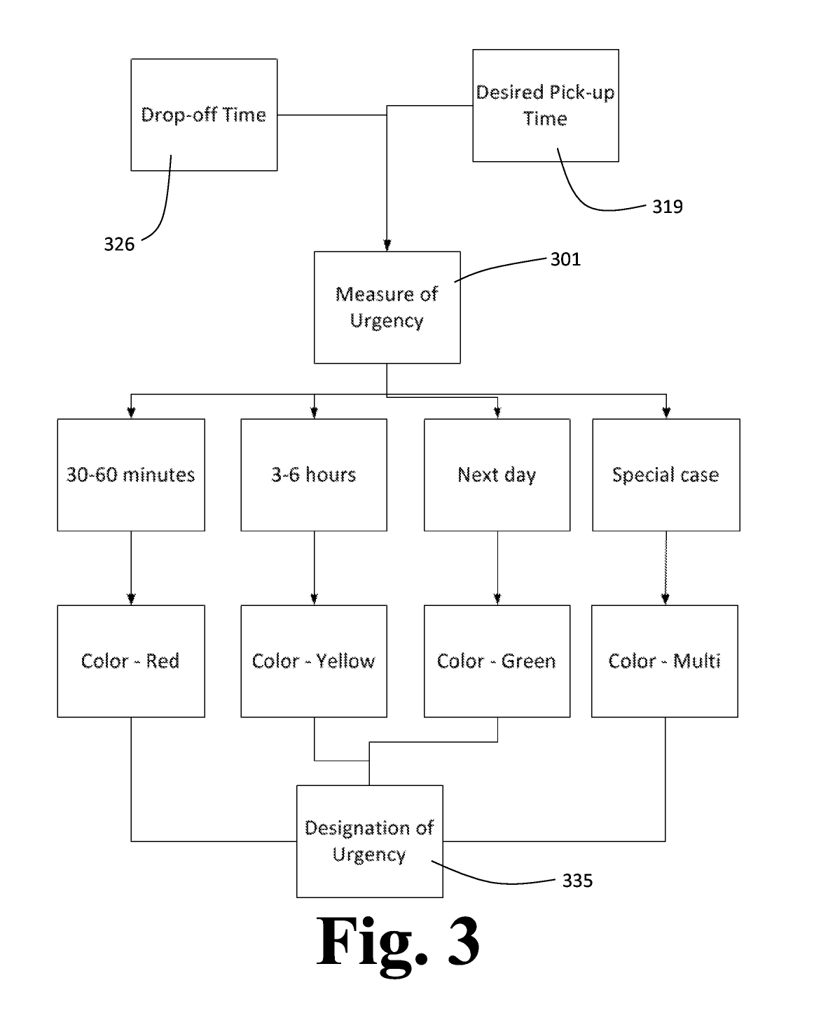

FIG. 3 illustrates a method for designating a measure of urgency 301 to an in-progress prescription. A prescription is received from a patient with an associated desired delivery time 319. Based upon the desired delivery time 319 and the arrival time 326, a measure of urgency 301 is assigned to the in-progress prescription. The measure of urgency 301 may include, for example, 30 to 60 minute delivery, 3 to 6 hour delivery, next day delivery, and special case delivery. Optionally, the measure of urgency 301 is comprised in the in-progress prescription retaining device. Accordingly, a designation for each measure of urgency is assigned. For example, a color may be assigned to each measure of urgency 301 including red for 30 to 60 minute delivery representing extremely urgent, yellow for 3 to 6 hour delivery representing urgent, green for next day delivery representing not urgent, and multi-colored for special case representing special exceptions with the prescriptions. In some embodiments, the designation of urgency 335 may be in the form of varying shapes such that the measure of urgency is recognized by a different shape assigned to each measure of urgency 301.

FIG. 4 shows a method of patient counseling 405 via a virtual medium such that the pharmacist does not have to be physically present when counseling a patient, thus reducing disruptions to the pharmacist and affording convenience to the patient to receive counseling at convenient times. Methods of virtual patient counseling includes, for example, pre-recorded video related to the prescription, real-time video allowing for face-to-face interaction, phone transmission allowing for real-time communication, text messaging allowing for real-time communication, pre-recorded voice transmission related to the prescription, pre-written descriptions accessible through various mediums, and combinations of these methods. Additionally, in the case of pre-recorded and pre-written methods, the virtual counseling 405 is accessed via codes or readable labels provided on the prescription final packaging including, for example, UPC code, QR code, reference number, picture, text, and still others. Often, pre-recorded and pre-written virtual counseling 405 is related to common prescriptions that are regularly counseled by the pharmacist, thus reducing the amount of repetitive counseling by the pharmacist. Conversely, uncommon prescriptions present the need for real-time counseling including video, phone, and text.

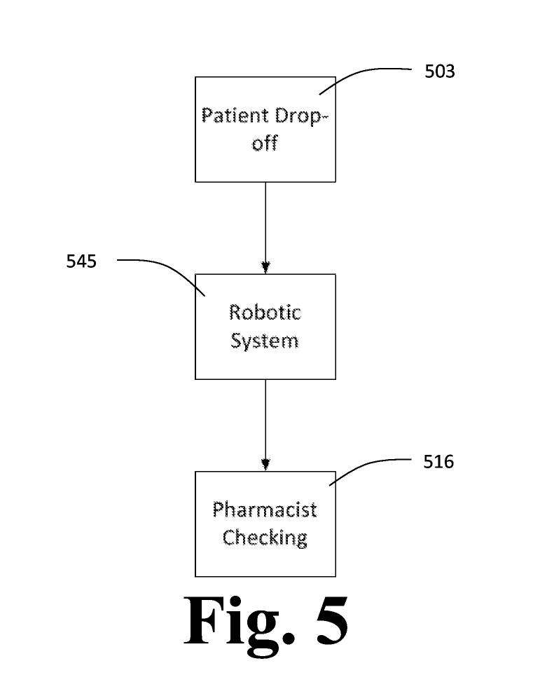

As shown in FIG. 5, a robotic system 545 is utilized to autonomously retrieve drug inventory and fill prescriptions prior to checking by a pharmacist. Optionally, the robotic system 545 is used in parallel with filling technicians to increase the volume of prescriptions filled. The robotic system 545 receives prescription orders following the initial verification steps and input at the patient drop-off station 503. The robotic system 545 then retrieves the drugs and fills the prescriptions without human interaction. The prescriptions are then organized for checking by the pharmacist 516 prior to final packaging.

FIG. 6 illustrates a method for managing in-progress prescriptions comprising arranging at least two horizontal rows 600 in a vertical orientation that retain in-progress prescription retaining devices 610. Optionally, the in-progress prescription retaining devices 610 are capable of hanging such that the retaining devices hang from a rack configuration that is capable of holding multiple retaining devices. Additionally, the in-progress prescription retaining devices 610 may be consistent with urgency designated retaining devices described in FIG. 3. Further, the in-progress prescription retaining devices 610 are organized according to arrival time. Further still, the in-progress prescription retaining devices 610 may comprise an additional pouch for retaining additional items needed for filling the prescription including, for example, prescription labels, patient information, additional prescription information, special instructions, and others.

Still referring to FIG. 6, a surface may further be positioned below the hanging structure of a horizontal row 600 such that the surface is coupled to the horizontal row 600 and the retaining devices 610 hang above the surface. The surface is configured to allow for the storage of larger items 623 that not capable of being hung and/or placed in a retaining device 610.

Again referring to FIG. 6, in some embodiments, each horizontal row 600 comprises at least one segment 636 that indicates the location of a desired in-progress prescription. Optionally, for example, the segments 636 correspond to separated lights such that each light corresponds to the location of a specific in-progress prescription. Accordingly, a technician indicates that an in-progress prescription is desired and the corresponding segment 636 lights up indicating the location of the in-progress prescription. This allows for quicker retrieval of desired in-progress prescriptions and eliminates the wasted time searching for a desired in-progress prescription. Optionally, for example, the segments 636 may indicate location audibly such that a sound is transmitted from the segment 636, thus providing and audible indication of the location of the in-progress prescription. Alternatively, the segment 636 transmits both an audible and visual indication of the location of an in-progress prescription. In some embodiments, at least one of the horizontal rows rotates such that an in-progress prescription can be located without having to substantially move.

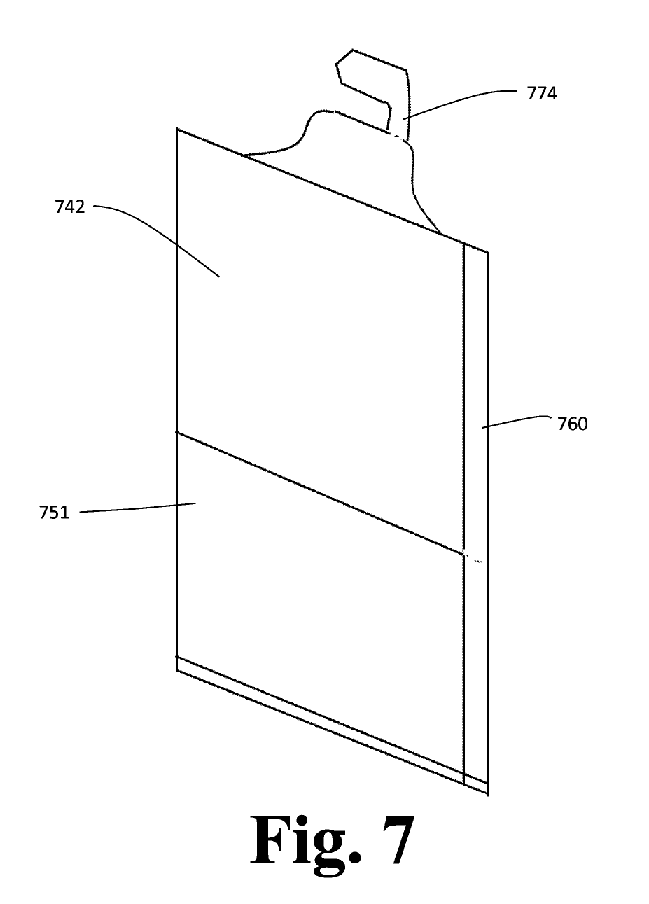

FIG. 7 shows an embodiment of an in-progress prescription retaining device that comprises two separated pouches, one designated for the prescription 742 and one designated for accompanying information 751 such as a prescription label. Optionally, the retaining device is transparent such that the contents of each pouch are visible from the outside of the retaining device. Further, the retaining device comprises a designation of urgency 760 as described in FIG. 3. Additionally, the retaining device comprises a structure extending upward from the top-end of the two pouches such that the structure allows for the hanging of the retaining device. The shape of the structure includes, for example, a C-shaped hook 774, a triangular hook, a clip, a snap feature, and others. As shown in FIG. 7, the C-shaped hook 774 mates with a corresponding hanging structure coupled to a horizontal row of an in-progress prescription management apparatus. The C-shaped hook 774 allows for the easy removal and replacement of the retaining device on the in-progress prescription management apparatus. Further, the transparency, separated pouches, and urgency designation provide for an increase in work flow and a decrease in filling and checking issues.

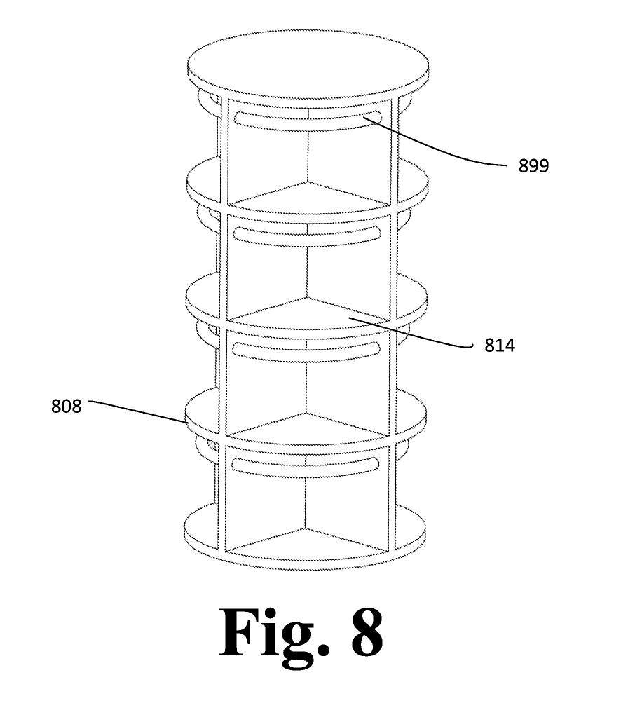

FIG. 8 illustrates an in-progress prescription management apparatus that comprises four horizontal rows 808 each having a hanging feature 899 to holds a plurality of retaining devices, consistent with the retaining devices shown in FIG. 7. Further, each horizontal row 808 comprises a surface 814 for retaining larger items and items that are not capable of being hung. Each horizontal row 808 is oriented vertically in relation to each other horizontal row. Further, each horizontal row 808 comprises a plurality of dividers that allow for isolating multiple prescriptions belonging to one patient or delivery destination. The divider provides further organization of the in-progress prescriptions, thus improving work flow and reducing errors.

In some embodiments, each horizontal row of an in-progress prescription management apparatus comprises a plurality of segments that correspond to at least one in-progress prescription. Each segment provides either visual indication, audible indication, or both for the location of an in-progress prescription. The segments and corresponding indications reduce the amount of time a technician or pharmacist must spend searching for a desired in-progress prescription.

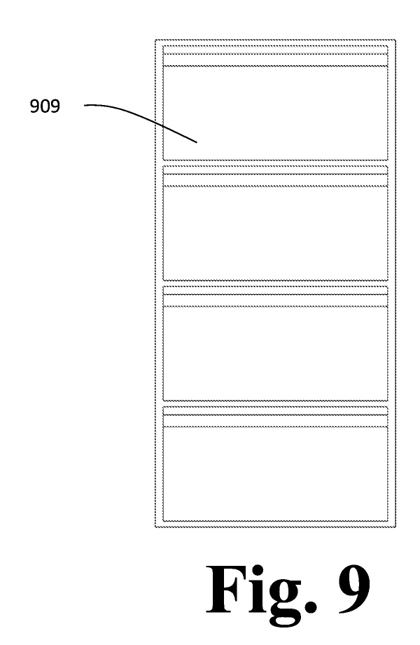

Referring now to FIG. 9, the in-progress prescription management apparatus comprises at least one horizontal row 909 that is straight and is defined by a straight-line segment. Accordingly, the vertically oriented horizontal rows 909 of this embodiment resemble the structure of a ladder such that each horizontal row 909 is a step in the ladder. Further, each horizontal row 909 allows for the movement of each hanging retaining device such that each retaining device can be moved as more urgent prescriptions are filled ahead of it, thus providing further organization of work flow. This embodiment further facilitates the location of the in-progress prescription management apparatus along the walls of a room or cubicle. This configuration further reduces the amount of horizontal working space required for the management of in-progress prescriptions.

It will be understood that the embodiments described herein are not limited in their application to the details of the teachings and descriptions set forth, or as illustrated in the accompanying figures. Rather, it will be understood that the method and apparatus for increasing work flow in a pharmacy, as taught and described according to multiple embodiments disclosed herein, is capable of other embodiments and of being practiced or carried out in various ways.

Also, it is to be understood that the phraseology and terminology used herein is for the purpose of description and should not be regarded as limiting. The use herein of “including,” “comprising,” “i.e.,” “containing,” or “having,” and variations of those words is meant to encompass the items listed thereafter, and equivalents of those, as well as additional items.

Accordingly, the descriptions herein are not intended to be exhaustive, nor are they meant to limit the understanding of the embodiments to the precise forms disclosed. It will be understood by those having ordinary skill in the art that modifications and variations of these embodiments are reasonably possible in light of the above teachings and descriptions.

What is claimed is:

1. A method of increasing work flow in a pharmacy, comprising:
arranging a first station that is configured to be substantially designated for filling prescriptions, wherein at least one technician fills prescriptions; and
arranging a second station that is configured to be substantially designated for checking prescriptions, wherein at least one pharmacist verifies prescriptions;
wherein the first station is located substantially separate from the second station such that the second station is isolated from the first station.

2. The method of claim 1, further comprising at least one additional station that is configured to be substantially designated for a purpose chosen from the group consisting of patient drop-off, packaging filled prescriptions, patient counseling, patient education, inventory management, in-progress prescription retaining and combinations thereof.

3. The method of claim 2, wherein at least one station is isolated from patient access.

4. The method of claim 1, further comprising at least one interactive voice response system that is configured to receive patient input and to convert said input into at least one prescription order.

5. The method of claim 4, wherein at least one interactive voice response system is further configured to provide advertisements and product suggestions based on said patient input.

6. The method of claim 1, wherein in-progress prescriptions are arranged to be substantially retained in at least one retaining device such that each retaining device has at least one designation indicative of urgency.

7. The method of claim 6, wherein the designation indicative of urgency is chosen from the group consisting of color, shape, and combinations thereof, such that each designation is indicative of at least one measure of urgency.

8. The method of claim 1, wherein at least one technician is capable of utilizing hands-free communication such that, without the use of hands, at least one task can be completed chosen from the group consisting of phone interaction, drive-up window interaction, hands-free typing, hands-free dialing, and any combination thereof.

9. The method of claim 1, further comprising at least one robotic system that is configured to fill prescriptions.

10. The method of claim 1, wherein patient counseling is configured to be completed virtually such that the pharmacist is not substantially located in the same physical area as the patient.

11. The method of claim 10, wherein the virtual method of patient counseling is chosen from the group consisting of pre-recorded video, real-time video, phone transmission, text messaging, pre-recorded voice transmission, pre-written description, and combinations thereof.

12. A method of in-progress prescription management, comprising:
arranging a first horizontal row that is configured to retain in-progress prescriptions such that in-progress prescriptions are retained in retaining devices that are capable of hanging from at least one structure coupled to the first horizontal row; and
arranging a second horizontal row in a substantially vertical orientation to the first horizontal row, wherein the second horizontal row is configured to retain in-progress prescriptions in a manner similar to the first horizontal row.

13. The method of claim 12, further comprising arranging at least one additional horizontal row in a substantially vertical orientation to the preceding horizontal rows.

14. The method of claim 12, wherein each retaining device has at least one designation indicative of urgency.

15. The method of claim 14, wherein the designation indicative of urgency is chosen from the group consisting of color, shape, and combinations thereof such that each designation is indicative of at least one measure of urgency.

16. The method of claim 12, wherein each retaining device is arranged to be organized according to arrival time.

17. The method of claim 12, wherein at least one retaining device comprises at least two pouches that are substantially segregated such that the contents of a first pouch are separated from the contents of a second pouch.

18. The method of claim 12, further comprising arranging at least one surface coupled to at least one horizontal row that is positioned below the coupled hanging structure of the same horizontal row.

19. The method of claim 12, wherein at least one horizontal row is configured to move about at least one axis such that the horizontal row rotates.

20. The method of claim 19, wherein at least one horizontal row rotates such that a desired inventory item is oriented in a manner that allows for uninhibited retrieval of said desired inventory item.

21. The method of claim 12, further comprising arranging horizontal rows into segments indicative of at least one in-progress prescription and configuring each segment to indicate the location of at least one in-progress prescription that is desired.

22. The method of claim 21, wherein each segment indicates the location of at least one in-progress prescription that is desired in a manner that is chosen from the group consisting of visual, audible, and combinations thereof.

23. An in-progress prescription management apparatus, comprising:
a first horizontal row having at least one hanging feature that is configured to substantially retain at least one in-progress prescription retaining device and at least one segment that is indicative of the location of at least one in-progress prescription;
at least one additional horizontal row oriented substantially vertical to a first horizontal row having at least one hanging feature that is configured to substantially retain at least one in-progress prescription retaining device and at least one segment that is indicative of the location of at least one in-progress prescription; and
at least one in-progress prescription retaining device having at least one designation of urgency.

24. The apparatus of claim 22, further comprising at least one divider that is arranged to substantially segregate at least one in-progress prescription retaining device from at least one additional in-progress prescription retaining device.
